(19) United States
(12) Patent Application Publication
(10) Pub. No.: US 2004/0242149 A1
(43) Pub. Date: Dec. 2, 2004

(54) Flexible mobile base station

(76) Inventor: Louis Luneau, Ville St-Laurent (CA)

Correspondence Address: OGILVY RENAULT, 1981 MCGILL COLLEGE AVENUE, SUITE 1600, MONTREAL, QC, H3A2Y3, CA

(21) Appl. No.: 10/446,161

(22) Filed: May 28, 2003

(51) Int. Cl. H04K 3/00

(52) U.S. Cl. 455/1; 455/422.1

(57) ABSTRACT

A flexible mobile base station is disclosed comprising a configurable wireless jamming unit, a configurable transceiver, a wireless spectrum analyzing unit, a processing unit and a wireless channels database.

### TECHNICAL FIELD

This invention relates to the field of telecommunications. More precisely, this invention pertains to mobile wireless telecommunications.

### BACKGROUND OF THE INVENTION

Mobile telephony represents now an important part of wireless telecommunications.

Mobile phones are easily available, usually affordable and provide users with great flexibility.

However, it may still be difficult to use a mobile phone in some areas. Besides the areas where no connection is available without a satellite connection, there are still some places where it is difficult or impossible to use a mobile phone. Examples of such areas include, but are not limited to, aircrafts, cruise boats, and any moving vessel in general.

In the case of aircraft, it has been contemplated that in some cases, improper use of mobile phones may create hazards to aircraft navigation/telecommunication equipments.

There have been various proposals in order to allow users to make and receive calls using a tracking radio link, usually using a satellite system, between the moving vessel and a ground station. One well known solution is to provide a system comprising a plurality of seat handsets. Such systems are in use in several airlines companies and are registered under the trademark “Skyphone”.

There has also been considerable research and development in recent years in order to enable the use of mobile telephones, instead of seat/fixed handset, onboard ships and aircraft. In such cases, a mobile telephone communicates with an onboard base station. The backhaul connection to a ground station is provided using a tracking radio link, which is usually satellite system, in order to establish a communication between the base transceiver station (BTS) and a ground station that is connected with the cellular network.

Such systems have been disclosed in patents and patent applications WO99/12227, WO94/28684, WO98/26521, EP 0920147, EP 0915577, EP 993067636, GB 2310973.

It will be appreciated that there are various circumstances where an onboard handset will not communicate with the onboard base station.

For example the handset transceiver cannot receive the base station signal because it does not operate in the same frequency spectrum.

In another case, the handset and the base station operate in the same frequency spectrum but are not operating in the same mode; e.g. they do not use the same air interface standard.

In another case, the handset and the base station operate in the same frequency band and use the same operating mode, however the handset maintains contact with another base station located in a surrounding area because the signal quality is good enough.

In another case, the handset and the base station operate with the same frequency band; there is no other base station with acceptable quality, however the handset still does not lock to the base station and searches for another base station because the information transmitted by the base station control channel does not meet criteria required by the handset to lock on the control channel and stay idle.

In another case, the user is already communicating using the handset and the latter has not been given an handoff signaling message that would have transferred the communication to the onboard base station.

### SUMMARY OF THE INVENTION

It is an object to provide a method for providing a wireless access to a plurality of users communicating on a plurality of frequency bands.

It is another object of the invention to provide a method for communicating between a plurality of users communicating on a plurality of frequency bands.

According to a first aspect of the invention, there is provided a method of assigning a wireless channel for communication between a base station and a mobile device comprising scanning a plurality of wireless channels, identifying active wireless channels within the plurality of wireless communication channels, in a database, assigning an active status to each one of the active wireless channels and configuring the base station to communicate with the mobile device on one of the wireless channels other than those to which an active status is assigned.

According to another aspect of the invention, there is provided a method for communicating between a plurality of mobile devices communicating on a plurality of wireless communication channels using a configurable wireless transceiver, the method comprising selecting a wireless communication channel for communicating with a mobile device of the plurality of mobile devices, checking if the selected wireless communication channel is a non-active wireless communication channel by accessing a database comprising a list of active wireless communication channels, if the checking is unsuccessful, reselecting a wireless communication channel, if the checking is successful, configuring the configurable wireless transceiver using the selected wireless communication channel and communicating with the mobile device using the configured wireless transceiver.

According to another aspect of the invention, there is provided a method for providing a virtual home base station to a mobile device communicating on an access provider wireless communication channel using a configurable wireless transceiver, comprising identifying at least one parameter of an access provider operating the mobile device on the access provider wireless communication channel, configuring the configurable wireless transceiver to communicate with the mobile device using the at least one parameter of the access provider operating the mobile device on the access provider wireless communication channel and a suitable wireless communication channel and jamming the access provider wireless communication channel.

### BRIEF DESCRIPTION OF THE DRAWINGS

Further features and advantages of the present invention will become apparent from the following detailed description, taken in combination with the appended drawings, in which:

FIG. 1 is a block diagram which shows a preferred embodiment of a configurable mobile base station;

FIG. 2 is a flow chart which shows how the configurable mobile operates in the preferred embodiment of the invention;

FIG. 3 is a flow chart which shows how the configurable mobile base station operates in the preferred embodiment of the invention;

FIG. 4a is a flow chart which shows how the configurable mobile base station is used in the preferred embodiment of the invention and when a request for a communication is received from a mobile device 17;

FIG. 4b is a flow chart which shows how the configurable mobile base station is used in the preferred embodiment of the invention.

It will be noted that throughout the appended drawings, like features are identified by like reference numerals.

### DETAILED DESCRIPTION OF THE INVENTION

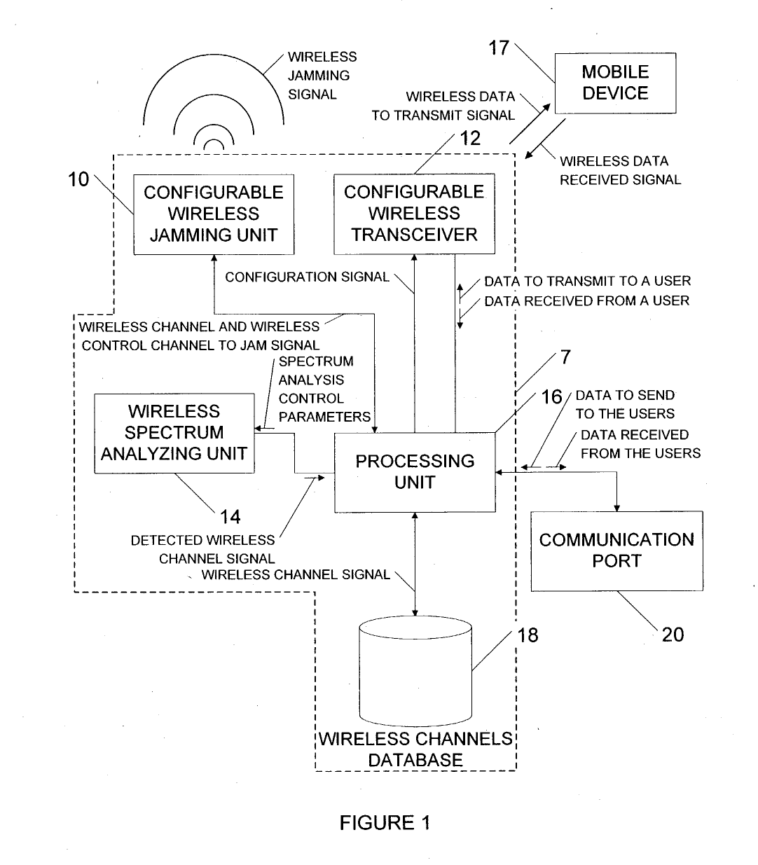

Now referring to FIG. 1, there is shown a preferred embodiment of the configurable mobile base station 7.

It will be appreciated that the configurable mobile base station 7 provides a wireless link to a plurality of mobile devices 17. The plurality of mobile devices 17 may access, using a communication protocol implemented in the configurable mobile base station 7, to any one of a data packet-switched network, such as IEEE802.11, a voice/data circuit-switched network, such as for instance a cellular network, a voice packet-switched network, such as trunk radio, or the like as will be shown below.

In the preferred embodiment, the implemented communication protocol provides a plurality of wireless communication channels and at least one wireless control channel.

Each channel of the plurality of wireless communication channels are those that may be used for a wireless communication between the configurable mobile base station 7 and a mobile device of the plurality of mobile devices according to the communication protocol implemented.

The at least one wireless control channel is used to provide control or signaling data between the configurable mobile base station 7 and the plurality of mobile devices 17 according to the communication protocol implemented. Such control or signaling data comprises but are not limited to Synchronization data, Public Land Mobile Network ID, as known by someone skilled in the art.

In the preferred embodiment of the invention, the configurable mobile base station 7 is mobile physically, but someone skilled in the art will appreciate that such configurable mobile base station 7 operates when it is static relative to its immediate environment physically.

In the preferred embodiment, the configurable mobile base station 7 and the plurality of mobile devices 17 are located in an aircraft.

Still referring to FIG. 1, the configurable mobile base station 7 comprises a configurable wireless transceiver 12, a configurable wireless jamming unit 10, a processing unit 16, a wireless spectrum analyzing unit 14, a wireless channels database 18 and a communication port 20.

The configurable wireless transceiver 12 is configured according to a configuration signal provided by the processing unit 16.

The configurable wireless transceiver 12 receives from the processing unit 16 “a data to transmit to a mobile device” signal. The configurable wireless transceiver 12 provides to the processing unit 16 a “data received from a mobile device” signal.

The configurable wireless transceiver 12 further provides to the mobile device a “wireless data to transmit” signal and receives from the mobile device a “wireless data received” signal.

Someone skilled in the art will appreciate that the “wireless data to transmit” signal and the “wireless data received” signal depend on the implemented communication protocol.

The processing unit 16 provides a “wireless channel and wireless control channel to jam” signal. The configurable wireless jamming unit 10 provides a wireless jamming signal according to the “wireless channel and wireless control channel to jam” signal provided.

The wireless spectrum analyzing unit 14 performs a spectrum analysis of a predefined spectrum band according to the spectrum analysis control parameters provided by the processing unit 16. In the preferred embodiment, the spectrum analysis control parameters comprise at least a selection of the service bands for the spectrum analysis, channel bandwidth, modulation (protocol) type, signal strength threshold and/or BER threshold.

The wireless spectrum analyzing unit 14 provides a plurality of detected wireless communication channels and at least one wireless control channel to the processing unit 16. The skilled addressee will appreciate that usually a plurality of control channels are detected and provided by the wireless spectrum analyzing unit 14. Preferably, the plurality of detected wireless communication channels and the at least one wireless control channel comprise, for each channel, a carrier frequency, a corresponding channel quality (power level (RSSI) and/or Bit Error Rate (BER)), a channel number, identifying if a corresponding channel is either a wireless communication channel or a wireless control channel and a modulation used. For each channel of the at least one control channel, the “plurality of detected wireless channels and at least one control channel” signal comprises corresponding Public Land Mobile Network (PLMN) ID called SID.

The wireless channels database 18 comprises, in the preferred embodiment of the invention, data identifying active wireless communication channels and active control communication channels. In an alternative embodiment, the wireless channels database 18 is remotely accessed by the processing unit 16.

The active wireless communication channels are communication channels that are used either by the configurable mobile base station 7 or by an other base station.

The active wireless control communication channels are control channels that are used either by the configurable mobile base station 7 or by an other base station.

An identifier is preferably used, in the wireless channels database 18, in order to identify a service provider in charge of each of the active wireless communication channels and the active wireless control communication channels.

The processing unit 16 further provides at least one part of the data received from the plurality of mobile devices 17 to the communication port 20. In the preferred embodiment of the invention, the communication port 20 is a satellite wideband communication port. It will be appreciated by someone skilled in the art, that the at least one part of the data received from the plurality of mobile devices 17 and provided to the communication port 20 are formatted according to a communication port protocol.

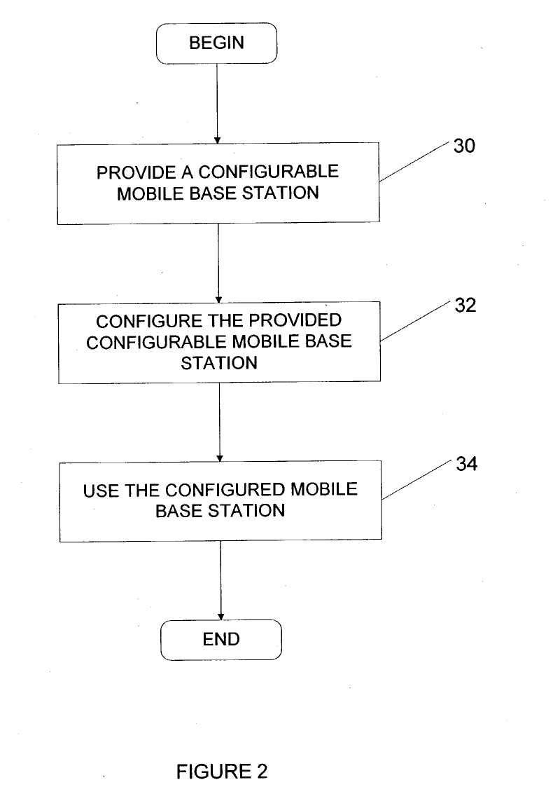

Now referring to FIG. 2, it is shown how the configurable mobile base station 7 operates.

According to step 30, the configurable mobile base station 7 is provided.

According to step 32, the configurable mobile base station 7 is configured.

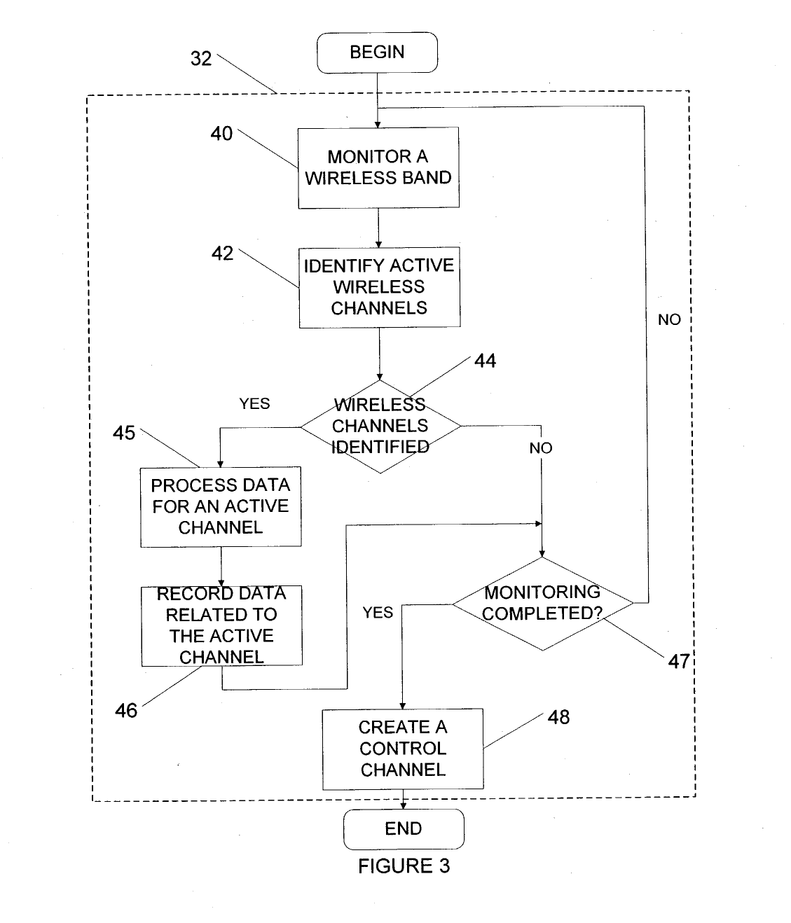

Now referring to FIG. 3, it is shown how the configurable mobile base station 7 is configured according to step 32 in the preferred embodiment.

According to step 40, a wireless band, comprising a plurality of channels, is monitored using the wireless spectrum analyzing unit 14. The wireless band is monitored according to the spectrum analysis control parameters.

According to step 42, wireless active channels are identified using the wireless spectrum analyzing unit 14. The identified wireless active channels comprise a plurality of detected wireless communication channels and at least one detected wireless control channel. Non-active wireless channels are available communication channels.

According to step 44, a test is performed in order to check if a wireless active channel is identified.

If no wireless active channel is identified then according to step 47, a test is performed to determine if the monitoring performed by the wireless spectrum analyzing unit 14 is completed or not.

In the case where the monitoring performed by the wireless spectrum analyzing unit 14 is not completed, a wireless band is monitored according to step 40.

In the case where a wireless active channel is identified, then according to step 45, data related to the identified wireless active channel are processed. In the preferred embodiment of the invention, such processing comprises identifying and recording carrier frequency of the wireless active channel, bandwidth, power level, type of modulation used for the wireless active channel, type of wireless active channel, i.e. control channel or communication.

For each wireless active control channel, the PLMN id (SID) is extracted as well as other configuration parameters provided to the mobile device 17. In another embodiment, a direction finder is provided. The direction finder estimates the angle-of-arrival of the wireless active channel identified.

It has been contemplated that step 45 is not mandatory.

According to step 46, data related to the wireless active channel and processed according to step 45 are recorded in the wireless channels database 18 by the processing unit 16.

After step 46, a test is performed according to step 47 in order to check if the monitoring, according to the spectrum analysis parameters, is completed.

Upon completion of the monitoring, and according to step 48, a mobile base station control channel is created for the configurable mobile base station. It will be appreciated that the mobile base station control channel is created depending on the type of mobile device 17.

It will be further appreciated that a flexible number of mobile base station control channel may be created. In the case where there are at least two subsets of mobile device 17, where a first subset of at least one mobile device 17 uses a first mobile service provider, while there is a second subset of at least one mobile device 17 which uses another mobile service provider, it is highly desirable to be possible to accommodate both subsets of mobile devices using two mobile base station control channels.

Alternatively, the flexible number of mobile base station control channel may be determined according to business deals between service providers or according to any other business schemes.

Upon completion of step 48, the configurable mobile base station 7 is fully configured.

At this point, it will be appreciated that after completion of step 32, the wireless channels database 18 comprises a “map” of all surrounding and detected wireless active channels; furthermore a flexible number of mobile base station control channel is created.

It will be appreciated that the step 32 of configuring the provided configurable mobile base station is performed continuously which is of great advantage in the case where the configurable mobile base station 7 is moving.

Now referring back to FIG. 2 and according to step 34, the configurable mobile base station 7 is used by at least one of the plurality of mobile devices 17. It will be appreciated that the mobile device 7 may belong to one of the Public Land Mobile Network (PLMN) operating in a surrounding geographic area, or alternatively may have a different Public Land Mobile Network than one operating in the geographic area. In the latter case, the mobile device 7 may be authorized to communicate with one of the Public Land Mobile Network operating in the geographic area because of an agreement between the two Public Land Mobile Network operators, such as a roaming agreement. In another case, the mobile device 7 may belong to a Public Land Mobile Network that has just been created according to the invention.

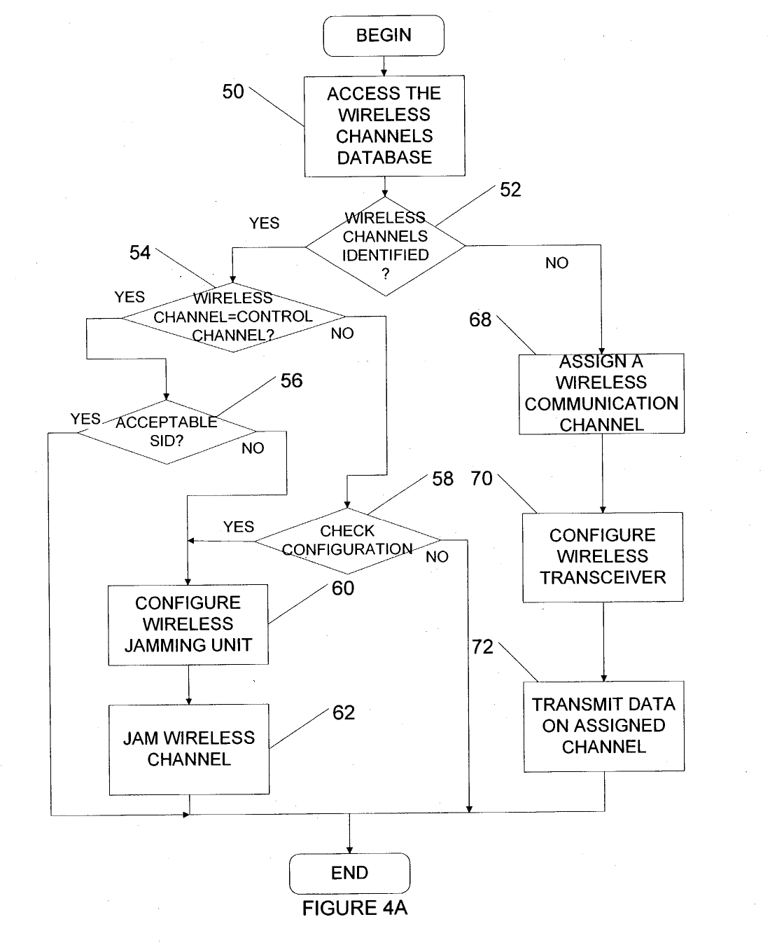

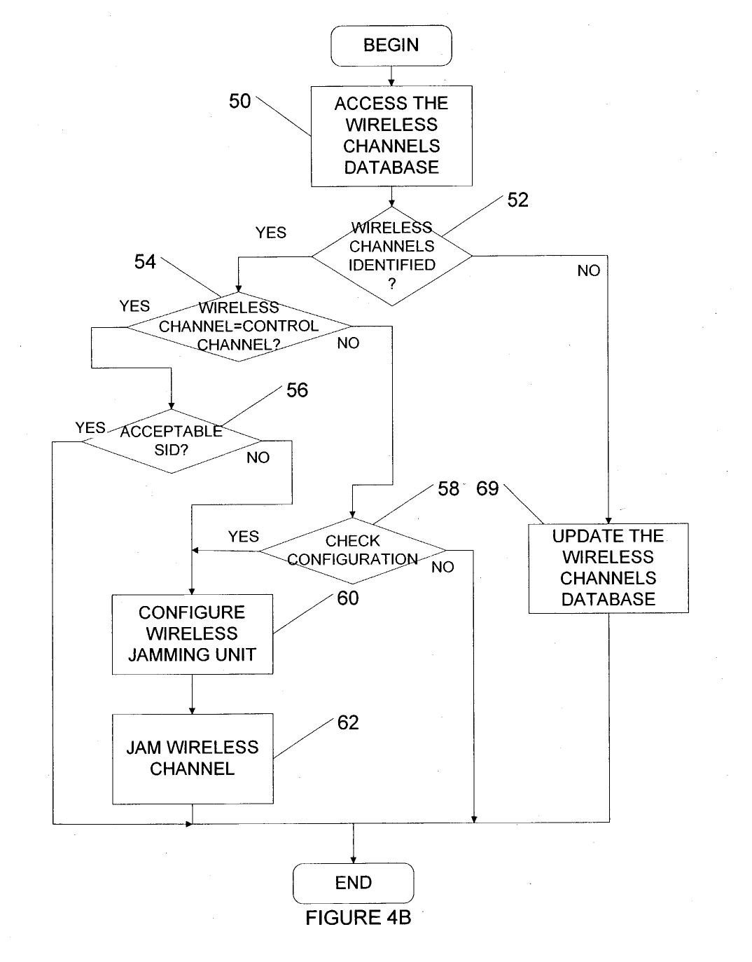

FIG. 4a shows how the configurable mobile base station 7 operates in order to have a mobile device 7 connecting to the configurable mobile base station 7, wherein the mobile device 7 is currently connected to a selected Public Land Mobile Network operating in the surrounding geographic area and further to have the mobile device 7 disconnect from the selected Public Land Mobile Network.

Now referring to FIG. 4b, there is shown how a mobile device 7, which belongs either to the Public Land Mobile Network that has just been created according to the invention or to a selected Public Land Mobile Network which operates in the surrounding geographic area, connects to the configurable mobile base station 7.

According to step 50, the wireless channels database 18 is accessed by the processing unit 16.

According to step 52, a check is performed by the processing unit 16 in the wireless channels database 18 in order to find out if there is at least one active wireless channel identified. It will be appreciated that each of the wireless active channels comprised in the wireless channels database 18 should be preferably identified by the configurable mobile base station 7 as explained above.

In the case where there is at least one wireless active channel identified, a test is performed according to step 54.

More precisely, according to step 54, the test is performed by the processing unit 16 in order to find out if the at least one wireless active channel identified is a wireless control channel. The skilled addressee will appreciate that such wireless control channels have SID while wireless communication channel usually do not comprise any SID identifier.

In the case where the at least one wireless active channel identified is a wireless control channel and according to step 56, a test is further performed in order to check if the wireless control channel is acceptable.

The test is preferably performed by the processing unit 16 using a corresponding Public Land Mobile Network (PLMN) identifier commonly called SID, stored in the wireless channels database 18. In an alternative embodiment, the test is performed using a base station ID.

In the case where the corresponding SID of the wireless control channel is not acceptable, and according to step 60, the configurable jamming unit 10 is configured by the processing unit 16 according to the wireless control channel.

According to step 62, the wireless control channel is jammed using the configurable wireless jamming unit 10.

It will be appreciated that in the case where the at least one wireless active channel is not a wireless control channel, the at least one wireless active channel is either an unknown type channel or a wireless communication channel.

According to step 58, a test of configuration is performed. It will be appreciated that depending on the application, it may be desirable or not to avoid any other type of traffic. The configuration is therefore set by a user according to a policy.

In the preferred embodiment of the invention, the test is performed, by the processing unit 16, using a corresponding Public Land Mobile Network identifier commonly called SID stored in the wireless channels database 18. It will be appreciated that in the case where the at least one wireless active channel is used by the configurable mobile base station 7, it is not desirable to jam it.

It will be appreciated, by the skilled addressee, that such test depends on a policy defined for the intended application. In some case it is highly desirable to jam all wireless channels while in some other case it is not.

In the case where the configuration does not allow an unknown wireless communication channel to operate in the vicinity of the configurable mobile base station 7 and according to step 60, the configurable jamming unit 10 is configured by the processing unit 16 according to the wireless active channel which is not a wireless control channel.

According to step 62, the wireless active channel, which is not a wireless control channel, is jammed using the configurable wireless jamming unit 10.

In the case where the configuration allows an unknown wireless communication channel to operate in the vicinity of the configurable mobile base station 7, no actions are taken against the wireless active channel which is not a wireless control channel.

In the case where there is at least one wireless channel that is not identified as active by the configurable mobile base station 7, and according to step 68, a wireless communication channel is selected from the at least one wireless channel which is not identified as active.

The selection is preferably performed by using the base station ID.

If the base station ID is the same that a base station ID of the configurable mobile base station 7 then there is a high level of confidence that the at least one wireless communication channel, which is not identified as active, is not used by another base station in the surrounding geographic area.

If the base station ID is not equal to a base station ID of the configurable mobile base station 7, the selecting of the at least one wireless channel may therefore create a risk that the at least one wireless communication channel is used in the future by a base station located in the surrounding geographic area.

Consequently, and in the preferred embodiment of the invention, such wireless communication channel should only be selected if there is no other alternatives.

Accordingly, non-active wireless channel identified using the mobile base station ID are preferably selected, followed by unknown base station id and finally by non-active channel identified with other base station id.

According to step 70, the configurable wireless transceiver 12 is configured by the processing unit 16 according to the wireless communication channel assigned to the mobile device 17.

According to step 72, data is transmitted to the mobile device 17 by the configurable wireless transceiver 12.

While FIG. 4a discloses the preferred embodiment of the invention, it will be appreciated that various alternative embodiments may be implemented. For instance, it will be appreciated that the jamming performed according to step 60 may be performed according to criteria such as the identity of a service provider or the like. Accordingly, it may be desirable to amend steps 56 and 58.

More precisely, it will be appreciated that the checks performed according to step 54 and 58 may be defined according to certain needs. For instance, it may be desirable to define an active channel as a non-acceptable channel depending on a wireless access provider for instance.

Someone skilled in the art will appreciate that it is possible, with the embodiment disclosed in FIG. 4a, to properly handle all wireless active channels by storing corresponding data in the wireless channels database 18. The corresponding data stored depend on whether a communication channel is jammed or not.

Now referring to FIG. 4b, there is shown another embodiment where no request to communicate is received by the configurable mobile base station 7.

It will be appreciated that in this embodiment and according to step 69, the wireless channels database 10 is updated in the case where there is not at least one wireless active channel for the configurable mobile base station 7.

Alternatively to the embodiment shown in FIG. 4a, and in the case where the mobile device 17 is a cellular mobile phone, the data transmitted on the active channel selected according to step 72 may be paging data, short message services, provided on control channel.

It will be appreciated, by someone skilled in the art that such paging data transmitting is of great advantage in the case where the configurable mobile base station 7 is implemented in an aircraft. People skilled in the art appreciate that it is usually forbidden to use electronic devices during critical periods of a flight such as during take-off and landing. Accordingly, the configurable mobile base station 7 may be advantageously used to provide paging data to each cellular mobile phone located in the plane to inform them to turn-off their cellular mobile phone. If the cellular mobile phone is still turned-on, the user will get a message.

Alternatively the configurable mobile base station 7 may be used to call all cellular mobile phone located in the aircraft. In the case where a cellular mobile phone is still turned-on, the cellular mobile phone will ring alerting onboard personnel that it is still turned-on. In the case where the user of the cellular mobile phone ringing answers the received call, the configurable mobile base station 7 may provide a recorded message inviting the user of the cellular mobile phone to turn-off its mobile phone.

Alternatively, it is possible to print a document comprising an indication of all cellular mobile phone which are still turned-on.

In the case where a cellular mobile device implements a shutoff message, it is possible to shutoff mobile device using the shutoff message.

Furthermore, it may be possible to identify a specific mobile device which does not comply with the request comprised in the paging data by collecting data identifying the specific mobile device.

Now referring back to FIG. 4a and according to step 72, the data to transmit to the mobile device 17 is transmitted on the assigned wireless communication channel. The transmitting of the data to transmit to the mobile device 17 is performed by first configuring the configurable wireless transceiver 12 according to the configuration signal and then by providing the data to transmit to the mobile device 17 to the configurable wireless transceiver 12.

The configurable wireless transceiver 12 then generates the “wireless data to transmit” signal and provides it to the mobile device 17.

In the preferred embodiment of the invention, the configurable wireless transceiver 12 is implemented using the flexible software transceiver disclosed in copending patent application U.S. Ser. No. 10/290,488, filed Nov. 8, 2002 and entitled “Flexible Software Radio Transreceiver”, the specification of which is incorporated by reference.

Still in the preferred embodiment, the wireless spectrum analyzing unit 14 is implemented in the flexible software radio transceiver disclosed in copending U.S. patent application Ser. No. 10/290,488.

Now referring to the copending U.S. patent application U.S. Ser. No. 10/290,488 and more particularly to FIG. 2, a suitable digital down converter 26 and a suitable wireless wideband receiving unit 22 are selected according to the spectrum analysis control parameters.

More precisely, the first switching unit 29 is configured according to a first switching unit configuration signal and the second switching unit 34 is configured according to a second switching unit configuration signal in order to receive a detected wireless channel signal. The detected wireless channel signal is provided to the processing unit 16.

Similarly, and still in the preferred embodiment of the invention, the configurable wireless jamming unit 10 is implemented using the flexible software radio transceiver. More precisely, the “wireless channel and wireless control channel to jam” signal is provided to the flexible software radio transceiver.

In the preferred embodiment, the jamming is performed by transmitting white noise data on the selected physical channel. As known by someone skilled in the art, the physical channel is a carrier frequency for a FDMA system, a time slot in a TDMA system, a set of code for a CDMA system. In another embodiment of the invention, the jamming is performed by transmitting a white noise signal on the synchronization channel. The processing unit generates the white noise signal in the digital domain. The first and second switching units are configured according to the wireless channel and wireless control channel to jam signal via the first switching unit configuration signal and the second switching unit configuration signal. Following the multiplexing of the physical channels on a carrier frequency, a digital up converter 27 is used to up convert the white noise signal provided. The up converted white noise signal is then provided to a suitable wireless wideband transmitting unit 21 and the wireless jamming signal is outputted.

As explained previously, the configurable wireless transceiver is preferably implemented using the flexible software radio transceiver disclosed in the copending patent application. It will therefore be appreciated that the configurable wireless transceiver may be used to create a wireless link with the mobile devices 17 using any one of Trunked radio band, cellular band, PCS band, Wireless LAN band, Bluetooth band, HomeRF band, by adding a wireless transceiver for each service band. If the communication protocol uses frequency division duplex technique then the configurable spectrum analyzing unit requires for each band also a transceiver. For time division duplex technique no additional flexible transceiver is required, etc.

It will therefore be appreciated that a very flexible service may therefore be provided.

The processing unit is implemented using any one of a quad-dsp, a single board computer card (SBC), a power PC card or a combination of all of the previously mentioned processors.

Still in the preferred embodiment of the invention, the communication port is implemented using a computer integrated telephony card (CTI) 204 disclosed in FIG. 9 of the incorporated by reference copending patent application.

Still in the preferred embodiment of the invention, the wireless channels database 18 is an array of data. Alternatively, the wireless channels database 18 is implemented using an SQL Database application software such as Oracle or Microsoft SQL.

The embodiments of the invention described above are intended to be exemplary only. The scope of the invention is therefore intended to be limited solely by the scope of the appended claims.

I claim:

1. A method of assigning a wireless channel for communication between a base station and a mobile device comprising:
scanning a plurality of wireless channels;
identifying active wireless channels within said plurality of wireless communication channels;
in a database, assigning an active status to each one of said active wireless channels; and
configuring said base station to communicate with said mobile device on one of said wireless channels other than those to which an active status is assigned.

2. The method as claimed in claim 1, further comprising jamming said active wireless channels.

3. The method as claimed in claim 2, wherein said active wireless channels comprise a plurality of wireless communication channels and at least one wireless control channel, further wherein said jamming is performed on said at least one wireless control channel.

4. A method for communicating between a plurality of mobile devices capable of communicating on a plurality of wireless communication channels using a configurable wireless transceiver, said method comprising:
selecting a wireless communication channel from said plurality for communicating with a mobile device of the plurality of mobile devices;
checking if said selected wireless communication channel is a non-active wireless communication channel by accessing a database comprising a list of active wireless communication channels;
if said checking is unsuccessful, reselecting a wireless communication channel;
if said checking is successful, configuring said configurable wireless transceiver using said selected wireless communication channel and communicating with said mobile device using said configured wireless transceiver.

5. The method as claimed in claim 4, further comprising scanning a predetermined list of wireless communication channels to identify a list of non-active wireless communication channels and a list of active wireless communication channels and building said database comprising said list of active wireless communication channels.

6. The method as claimed in claim 5, further comprising jamming each of said active wireless communication channels.

7. The method as claimed in claim 6, wherein said scanning comprises measuring an indication of a power level for each of said active wireless communication channel, further wherein each of said indication of a power level for each of said active wireless communication channels is stored in said database, wherein said jamming is performed at a power level substantially equal to said indication of said power level.

8. The method as claimed in claim 4, wherein said communicating with said mobile device using said configured wireless transceiver comprises sending a message to shut-down said mobile device.

9. The method as claimed in claim 8, wherein said message to shut-down said mobile device comprises at least one of a recorded voice message and a SMS message.

10. A method for providing a virtual home base station to a mobile device communicating on an access provider wireless communication channel using a configurable wireless transceiver, comprising:
identifying at least one parameter of an access provider operating the mobile device on the access provider wireless communication channel;
configuring the configurable wireless transceiver to communicate with the mobile device using the at least one parameter of the access provider operating the mobile device on the access provider wireless communication channel and a suitable wireless communication channel; and
jamming the access provider wireless communication channel.

11. The method as claimed in claim 10, wherein a plurality of virtual home base stations are provided to a plurality of mobile devices, each of said mobile devices communicating on an access provider wireless communication channel.
